(19) United States
(12) Patent Application Publication
(10) Pub. No.: US 2017/0174390 A1
(43) Pub. Date: Jun. 22, 2017

(54) A BOX CAPABLE OF BEING ASSEMBLED AND DISASSEMBLED

(71) Applicant: Paul Clark, Somerset (GB)

(72) Inventor: Paul Clark, Somerset (GB)

(21) Appl. No.: 15/118,427

(22) PCT Filed: Feb. 6, 2015
(86) PCT No.: PCT/GB2015/050339

§ 371 Date: Aug. 11, 2016

(30) Foreign Application Priority Data
Feb. 12, 2015 (GB) 1402446.7

(51) Int. Cl. B65D 6/26; E05G 1/024; E05B 35/00; E05G 1/04; E05C 17/40; E05B 65/00; B65D 6/02; E05G 1/00

(52) U.S. Cl. CPC B65D 7/32; B65D 7/06; E05G 1/024; E05G 1/005; E05G 1/04; E05C 17/40; E05B 65/0075; E05B 35/00

(57) ABSTRACT

A simplified lockable box which can be disassembled and assembled as required is described. The box (10) comprises at least three sidewalls (30, 60, 90), a base (20), a lid (40), and at least three removably insertable side locking rods (100), wherein the base (20) and at least one sidewall (60) comprise base connection means (26, 21) for releasably connecting the at least one sidewall (60) with the base (20), and each sidewall (30, 60, 90) comprises side connection means (61, 71) arranged to accept the insertion of a side locking rod (100), such that with the box (10) at least partially assembled each side locking rod (100) releasably retains two adjacent sidewalls (30, 60, 90) together, and wherein the box (10) is arranged such that with the lid (40) in the closed position the side locking rods (100) are prevented from being removed.

The present invention relates generally to a box capable of being assembled and disassembled and finds particular, although not exclusive, utility in the provision of a safe.

To safeguard property it is known to use metal strongboxes or safes. Tool stores are an example of such a box, often used on construction sites. However, these boxes can be relatively bulky and heavy with the larger ones require lifting equipment to move. It is therefore desirable to have a strongbox or safe which is able to be moved more easily and yet provide adequate security.

In a first aspect, the invention provides a box capable of being assembled and disassembled comprising at least three sidewalls, a base, a lid, and removably insertable side locking rods, wherein the base and at least one sidewall comprise base connection means for releasably connecting the at least one sidewall with the base, and the sidewalls comprise side connection means arranged to accept the insertion of one of the side locking rods, such that with the box at least partially assembled each side locking rod releasably retains two adjacent sidewalls together, and wherein the box is arranged such that with the lid in the closed position the side locking rods are prevented from being removed, the box further comprising a removably insertable lid locking rod, and one of the sidewalls and the lid comprise lid connection means arranged to accept the insertion of the lid locking rod, so as to releasably retain the lid thereto, and wherein the box is arranged such that with the lid in the closed position the lid locking rod is prevented from being removed.

By virtue of the box being able to be disassembled the individual elements (sidewalls, base, lid etc.) are each far lighter than the whole assembled box. This means that the box can be moved easily by a single person. Furthermore, the individual elements when stacked together provide a “flat-pack” product which reduces its volume. This has benefits for storage and transportation.

An aim of the invention is to provide a relatively easy method of assembly and disassembly requiring no tools, nuts, bolts, screws or other such fixing/attachment means.

The box could have three sidewalls such that it is triangular in plan, however, it is expected that four sidewalls providing a box being rectangular in plan will be preferred. It is to be understood that the box may have more than four sidewalls.

At least two sidewalls may be hinged together such that when disassembled they may lie substantially parallel to one another. For instance, in a box having four sidewalls, three of the sidewalls may be hinged together along their sides with two separate hinges. In this manner, only one of the three sidewalls and the fourth sidewall may include base connection means. The hinge pin in the hinge(s) may be removable.

The side connection means may be arranged in the internal corners of the assembled box, or may be arranged externally to the box. In one embodiment, there may be a combination of internally and externally arranged side connection means. The lid may extend over the side connection means to prevent the removal of the side locking rods.

The side locking rods may have a circular cross-section but other cross-sectional shapes are contemplated. The rods may be at least partially hollow. The rods may be rigid or flexible. The rods may have a diameter of 10 mm.

The box may be further arranged such that the lid locking rod may be prevented from removal by a side locking rod. To remove the lid locking rod, the side locking rod may have to be removed initially.

The lid locking rod may have a circular cross-section but other cross-sectional shapes are contemplated. The rod may be at least partially hollow. The rod may be rigid or flexible. The rod may have a diameter of 10 mm.

The side connection means may be arranged such that the side locking rods are internal to the box in their inserted positions.

The box may further comprise a lock for locking the lid in a closed position.

The base, sidewalls and lid may comprise sheet metal, although aluminium is also contemplated. In this regard, the sheet may be 1 mm or 2 mm thick although other dimensions are contemplated. The sheet metal may be powder coated, although other finishes are contemplated. The side connection means and lid connection means may be formed from the sheet metal by cutting and bending such that no, or a limited amount only, of welding during initial fabrication of the box is required. Materials other than sheet metal are contemplated such as plastics.

The base may comprise at least one foot. This may be a continuous foot around the perimeter of the base or a plurality of individual feet arranged across the base. The feet may elevate the base off the surface on which the box is standing. The feet may aid the connection of the sidewalls to it as will be explained below. The base may comprise means, such as holes, for fixing the box to another surface. For instance, the box may be bolted to a floor. The base may include stiffening or reinforcing means such as a bar or channel section.

The base connection means may include slots in the base and corresponding base tabs projecting from the at least one sidewall, the base tabs may comprise a first portion co-planar with the at least one sidewall and a second portion in a plane substantially perpendicular to the first portion such that with the at least one sidewall connected to the base the first portions may be arranged in the slots and the second portions may lie beneath, and substantially parallel to, the base.

If the base tabs are initially separate from the sidewalls and are affixed to them then the first portions may not be co-planar with the sidewalls but may have planes parallel to the sidewalls' planar surfaces.

The base tabs may have an “L” shape formed at least by the first and second portions. However, the base tabs may be at least partially curved with the first and second portions only forming relatively small portions of the base tabs.

In use, the sidewall in question may be presented to the base such that the planar surfaces of the sidewall and base are substantially parallel to one another. The base tabs are then inserted into the slots, and the side wall is rotated away from the base into an upright position.

The side connection means may comprise at least one wall tab provided along each of the two opposite sides of one of the at least three sidewalls, and at least one wall tab provided along at least one side of each of the two other sidewalls, each wall tab configured to accept a side locking rod inserted in a first direction and prevent the rod from moving in a second direction, perpendicular to the first direction, when two or more lid tabs are adjacent one another.

In one example a wall tab may have a first portion lying in a plane substantially perpendicular to the plane of the sidewall to which it is connected, or with which it is integral, and a second portion lying in a plane substantially parallel to the plane of that sidewall.

The wall tabs may have an “L” shape formed at least by the first and second portions. However, the wall tabs may be at least partially curved with the first and second portions only forming relatively small portions of the wall tabs. The wall tabs may be substantially triangular when viewed in the direction in which the rods are inserted. Other cross-sectional shapes are contemplated such as circular. Any of the tabs may be have a complete, or substantially complete, box-like section such that the rods, when inserted, are completely, or substantially completely enclosed therein.

The wall tabs are arranged along the sides of the sidewalls such that the wall tabs on one sidewall do not interfere with the walls tabs on an adjacent sidewall. They may be arranged to form a continuous or discontinuous channel when two sidewalls are arranged adjacent one another; the channel for receiving the side locking rod.

If two sidewalls are hinged together and the box only has three sides then each outer side of the two hinged sidewalls may include wall tabs and the third side may include wall tabs on each of its opposite sides. In this way, only two channels would be formed requiring only two side locking rods. If the box has four sides none of which are hinged together then each side may require side connection means at each of its opposite sides. In this way, four channels would be formed requiring four side locking rods.

In use, the sidewalls are connected to the base and then rotated away from the base into an upright position thus forming the channels in each corner. The side locking rods may then be insertable to retain the sides together.

The lid connection means may comprise at least one lid tab provided on the upper side of the sidewall and at least one lid tab provided on the lid, each lid tab configured to accept a lid locking rod inserted in a first direction and prevent the rod from moving in a second direction, perpendicular to the first direction, when two or more lid tabs are adjacent one another. In one example, a lid tab may have a first portion lying in a plane substantially perpendicular to the plane of the sidewall or lid to which it is connected, or with which it is integral, and a second portion lying in a plane substantially parallel to the plane of that sidewall or lid.

The lid tabs may have an “L” shape formed at least by the first and second portions. However, the lid tabs may be at least partially curved with the first and second portions only forming relatively small portions of the lid tabs. The lid tabs may be substantially triangular when viewed in the direction in which the rods are inserted. Other cross-sectional shapes are contemplated such as circular.

The lid tabs are arranged along the side of the sidewall and lid such that the lid tabs on the sidewall do not interfere with the lid tabs on the lid. They may be arranged to form a continuous or discontinuous channel when arranged adjacent one another; the channel for receiving the lid locking rod.

In one embodiment, the lid may be hinged to the sidewall with one or more standard hinges. The hinge pin(s) may be removable from the standard hinges. The standard hinge may be a piano hinge.

The lid may comprise a side locking rod receiving means for receiving one end of a side locking rod for retaining the lid in an open position. With the lid connected to the box it may be hingably opened and one of the side locking rods may be lifted at least partially out of the corner channel, formed by the interlocking sidewall connection means. At the upper end of the side locking rod an arm may be provided for fitting within one of a series of slots formed on the lid to retain the lid in its open position.

The box may further include a door fixing member comprising a first member, integral with or fixed to the box, at least a portion of the first member being arranged to fit between a door and the door frame or door threshold, and a second member having a plane substantially perpendicular to the first member, wherein, in use, the first member is slidable between a door and the door frame or door threshold such that with the door closed the box is substantially immovable away from the door by virtue of the second member.

The phrase “L” shape may mean having two arms substantially perpendicular to one another.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

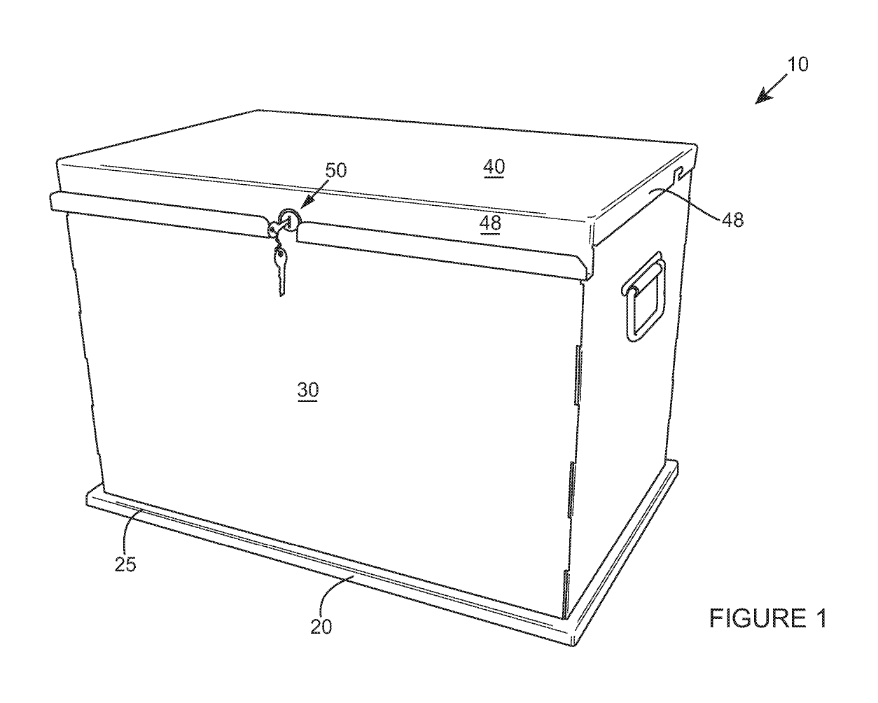

FIG. 1 is a perspective view of an assembled box with its lid in the closed position;

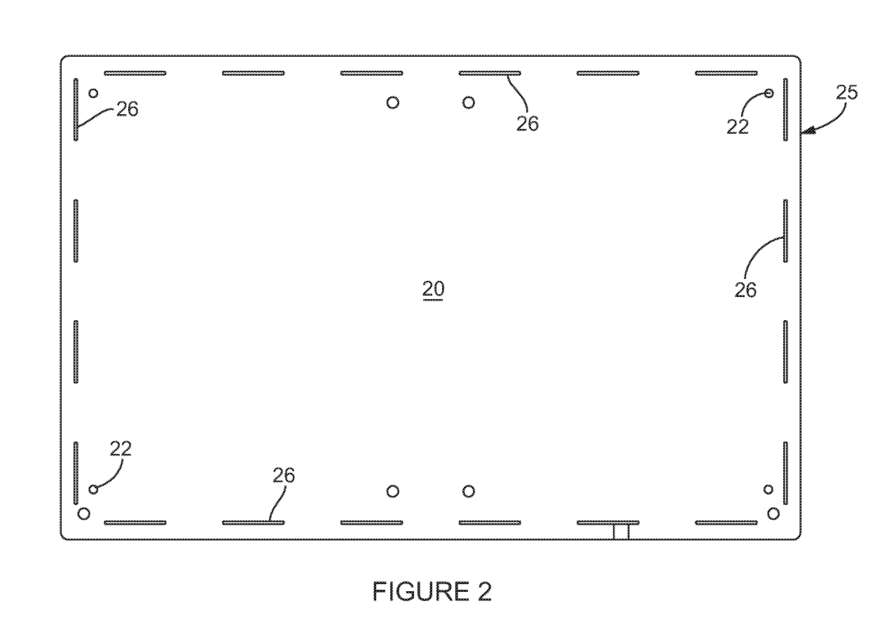

FIG. 2 is a plan view of the base of the box;

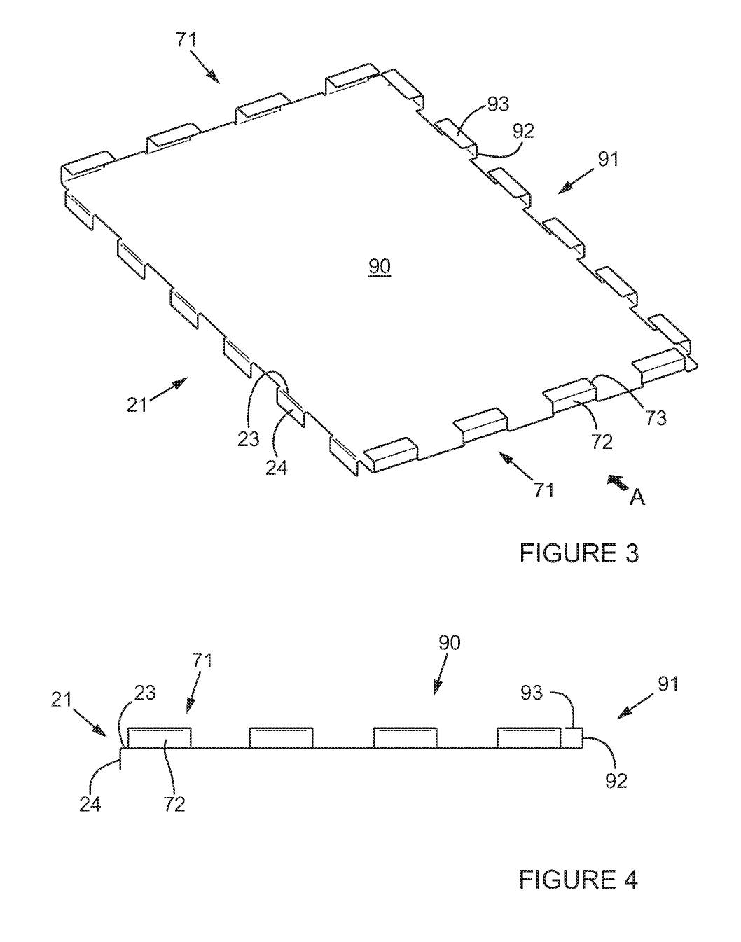

FIG. 3 is a perspective view of the rear sidewall of the box;

FIG. 4 is an end-on view of the rear sidewall of FIG. 3;

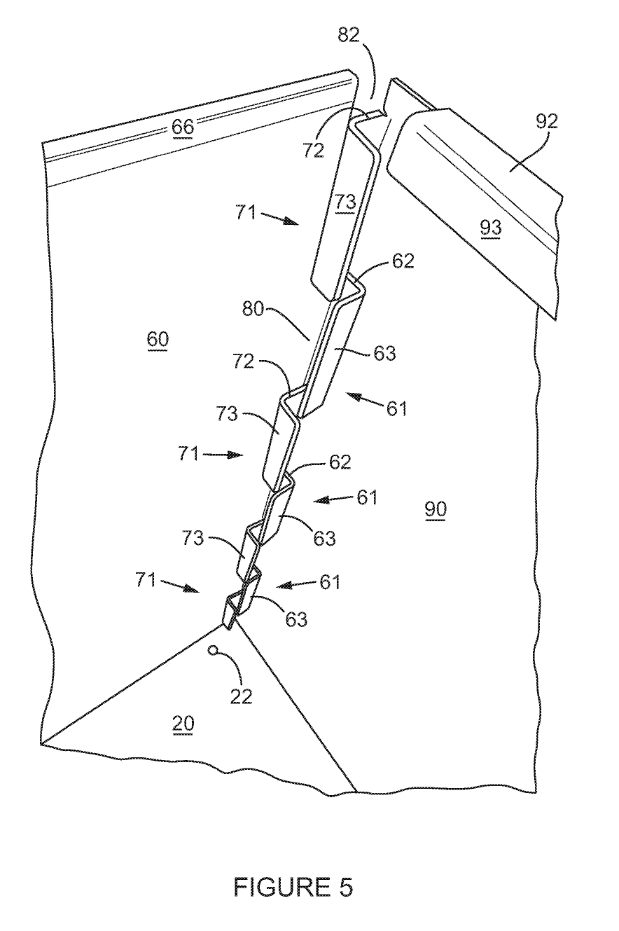

FIG. 5 is a close-up view of a portion of the channel formed between two adjacent sidewalls;

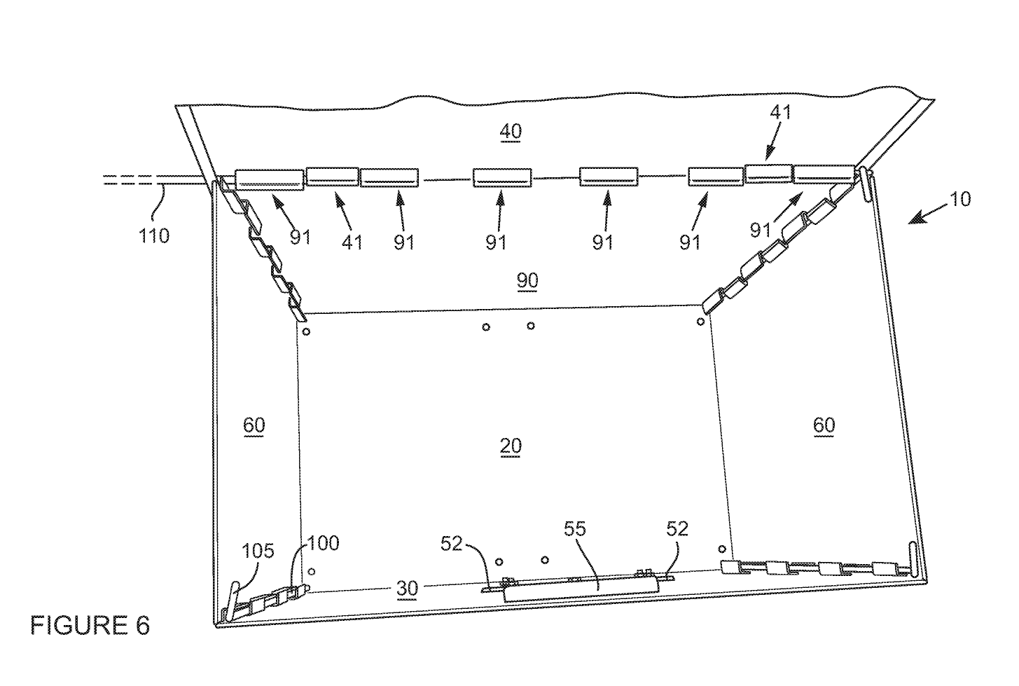

FIG. 6 is a view from above the assembled box with its lid in the open position;

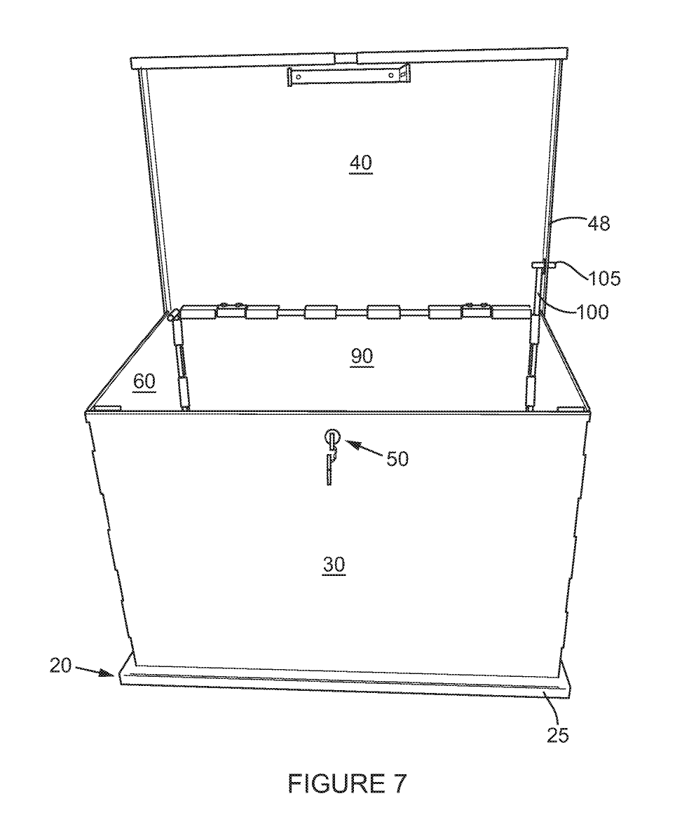

FIG. 7 is a perspective view of the assembled box with its lid retained in the open position;

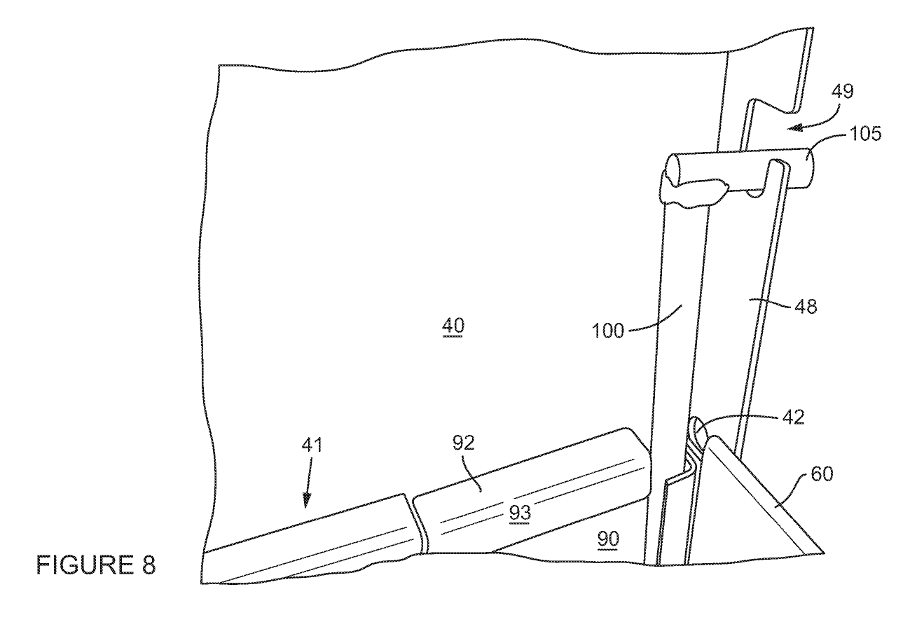

FIG. 8 is a close-up view of the lid retaining assembly; and

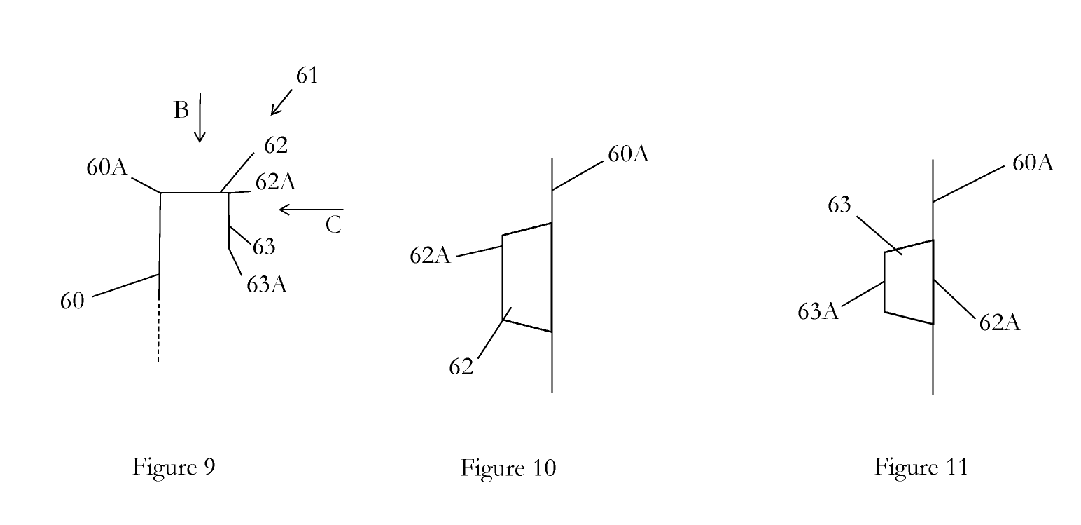

FIGS. 9 to 11 are views of an alternative tab configuration.

The present invention will be described with respect to certain drawings but the invention is not limited thereto but only by the claims. The drawings described are only schematic and are non-limiting. Each drawing may not include all of the features of the invention and therefore should not necessarily be considered to be an embodiment of the invention. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that operation is capable in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that operation is capable in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

The term “substantially” may mean either exactly or approximately.

Reference throughout this specification to “an embodiment” or “an aspect” means that a particular feature, structure or characteristic described in connection with the embodiment or aspect is included in at least one embodiment or aspect of the present invention. Thus, appearances of the phrases “in one embodiment”, “in an embodiment”, or “in an aspect” in various places throughout this specification are not necessarily all referring to the same embodiment or aspect, but may refer to different embodiments or aspects. Furthermore, the particular features, structures or characteristics of any embodiment or aspect of the invention may be combined in any suitable manner, as would be apparent to one of ordinary skill in the art from this disclosure, in one or more embodiments or aspects.

Similarly, it should be appreciated that in the description various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Moreover, the description of any individual drawing or aspect should not necessarily be considered to be an embodiment of the invention. Rather, as the following claims reflect, inventive aspects lie in fewer than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some features included in other embodiments, combinations of features of different embodiments are meant to be within the scope of the invention, and form yet further embodiments, as will be understood by those skilled in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

In the discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The use of the term “at least one” may mean only one in certain circumstances.

The principles of the invention will now be described by a detailed description of at least one drawing relating to exemplary features of the invention. It is clear that other arrangements can be configured according to the knowledge of persons skilled in the art without departing from the underlying concept or technical teaching of the invention, the invention being limited only by the terms of the appended claims.

In FIG. 1, the box 10 is shown with the lid 40 in the closed position. The front sidewall 30 is visible resting on and connected with the base 20. The lid 40 and front side walls 30 are both planar and rectangular. A keyhole 50 for activating the lock mechanism is arranged midway along the upper portion of the front sidewall 30. With the lid closed and locked none of the side connection or lid connection means are visible or accessible rendering the box unable to be disassembled. The lid 40 includes a lip 48 depending from the planar panel extending around the two sidewalls and front sidewall of the box 10.

A plan view of the base 20 is shown in FIG. 2 comprising a planar and rectangular platform resting on a foot 25 (refer also to FIG. 1) which extends around the perimeter of the base. Slots 26 through the base 20 are arranged in a rectangular pattern around its perimeter from its upper side to underside. These slots 26 are arranged to accept base tabs 71 as described below. Each slot has its longitudinal length arranged parallel to the side of the base to which it is closest.

The rear side wall 90 is depicted in FIG. 3. It comprises another planar and rectangular member. Along one side are arranged the base tabs 21. Each of these comprises a first portion 23 coplanar with, and extending radially away from, the rear side 90. The length of these first portions 23 may be relatively short. At the distal end of each first portion 23 a second portion 24 extends away perpendicularly. During assembly the rear sidewall 90 may be placed parallel to the base 20 such that the second portions 24 enter into the appropriate slots 26 in the base 20. The rear sidewall 90 may then be rotated away from the base 20 such that the second portions 24 become parallel with the base 20 and the rear sidewall stands up vertically from the base.

The rear side wall 90 thus cannot be removed from the base as the second portions 24 are beneath the base.

Along the two sides of the rear sidewall 90 wall tabs 71 are arranged. Each wall tab 71 comprises a first portion 72 which extends away from the sidewall 90 in a perpendicular manner and at its distal end a second portion 73 which turns radially inward, relative to the rear sidewall, such that it is parallel to the rear sidewall 90. The use of these wall tabs is explained in more detail below with reference to FIG. 5.

Along the top side of the rear sidewall 90 lid tabs 91 are arranged. These are similar to the wall tabs 71 in that each comprises a first portion 92 which extends perpendicularly away from the rear sidewall 90 and a second portion 93 which extends perpendicularly away from the first portion 92, radially inward and parallel to the rear side wall 90.

In FIG. 4 a view of the rear sidewall 90 is shown looking in the direction of arrow “A” indicated in FIG. 3. On the left hand side of the rear sidewall 90 the base tabs 21 are visible comprising the first and second portions 23, 24. On the right hand side of the rear sidewall 90 the lid tabs 91 are visible comprising the first and second portions 92, 93. Along the top of the rear sidewall 90, as shown in FIG. 4, the wall tabs 71 are visible comprising the first and second portions 72, 73.

It will be noted that the second portions 24 of the base tabs 21 extend below the planar surface of the rear sidewall 90 whereas the wall and lid tabs 71, 91 extend above this surface.

Although not shown, the sidewalls 60 and front sidewall 30 also include base tabs 21 and wall tabs in a similar manner to that described with regard to the rear sidewall 90. However, no lid tabs 91 are provided. Also, the lid 40 includes lid tabs 91 arranged along one side thereof for interaction with the lid tabs 91 provided along the top side of the rear sidewall 90.

In FIG. 5 the rear sidewall 90 together with one of the sidewalls 60 are shown. Although not visible, the rear sidewall 90 and sidewall 60 are connected to the base 20 by means of their respective base tabs 21.

The wall tabs 61 of the sidewall 60 and the wall tabs 71 of the rear sidewall 90 are alternately arranged in the corner formed by the sidewalls and rear sidewall. It is seen how the first portions 62 of the wall tabs 61 belonging to the sidewall 60 act to limit the movement of the rear sidewall 90, radially inward relative to the box 10, in that they act as a buffer, pressing against the rear sidewall. Similarly, the first portions 72 of the wall tabs 71 belong to the rear sidewall 90 act to limit the movement of the sidewall 60, radially inward relative to the box 10, in that they act as a buffer pressing against the sidewall.

The second portions 63, 73 together form a channel 80 parallel to the height of the sidewall and rear sidewall, and located in the corner thereof. With a sidewall locking rod 100 (refer to FIG. 6) inserted in this channel 80 the second portions 63, 73 act to prevent movement of the sidewall 60 and rear sidewall 90 radially outward relative to the box 10.

A cut-out notch 82 is provided at the top of the sidewall 60 adjacent the corner with the rear sidewall 90 to allow the lid locking rod 110 (refer to FIG. 6) to be inserted into a similar channel formed between the interlocking lid tabs 91 of the lid 40 and rear sidewall 90. In this regard one of the lid tabs 91 is visible in FIG. 5 comprising a first portion 92 extending away, and radially inward, from the top of the rear sidewall 90 parallel to the base 20, and a second portion 93 extending vertically downwards towards the base 20 from the distal end of the first portion 92 and parallel with the rear sidewall 90.

It is to be noted that the top side or edge 66 of the sidewall 60 has been turned over through 180 degrees. This is to prevent the sharp edge of the sidewall 60 injuring users. Finally, a hole 22 is indicated in the base 20 for allowing the box to be screwed down or otherwise anchored to a surface.

Turning now to FIG. 6, the almost completely assembled box 10 is shown comprising the base 20, the front sidewall 30, the two sidewalls 60 and the rear sidewall 90. Side locking rods 100 are shown present in the channels 80 created between the front sidewall 30 and the two sidewalls 60. Further more, a side locking rod is shown present in the channel 80 created in the corner between the right hand sidewall 60 and the rear sidewall 90. However, no side locking rod 100 is shown present in the channel 80 created in the corner between the left hand sidewall 60 and the rear sidewall 90. This is because the box is arranged such that the lid locking rod 110 can only be inserted in to the channel created between the lid 40 and the rear sidewall 90 with one side locking rod 100 temporarily missing. This is because the side locking rod 100 extends up as far as the entrance to the channel created between the lid 40 and the rear sidewall 90.

In FIG. 6 the lid locking rod 110 is shown inserted half-way into the channel created between the lid tabs 41 of the lid 40 and the lid tabs 91 of the rear sidewall 90. Once it has been fully inserted, the last side locking rod 100 may be inserted into the channel created between the side wall 60 and the rear sidewall 90. In this regard, the lid locking rod may be substantially rectilinear and include no arms extending away from its length. When in position, the lid locking rod is trapped between the two side locking rods. To facilitate the insertion of the lid locking rod a hole (referenced “42” in FIG. 8) may be provided in the lip 48 of the lid 40 to facilitate the lid locking rod to be inserted. A hole 42 may be provided at both ends of the lip 48 in the vicinity of the lid tabs to facilitate the lid locking rod to be inserted from either side.

Each side locking rod 100 comprises an arm 105 extending away from the top of the rod perpendicularly. These arms 105 facilitate the rods' insertion into, and removal from, the channels.

Only two lid tabs 41 are shown in FIG. 6, however, it will be appreciated that further lid tabs 41 may be provided to occupy the spaces between the lid tabs 91 provided on the rear sidewall 90.

Also visible in FIG. 6 is the locking mechanism 55 arranged on the inside surface of the front wall 30. It comprises two arms 52 which are retractable and extendable relative to the mechanism 55. These arms 52 are extendable into two slots arranged on the lid (not shown) to lock the box. A cover may be included (not shown) which protects the arms from accidental damage and/or bending.

FIG. 7 shows the box 10 in the fully assembled state with the lid 40 in the open position. The lid 40 comprises a planar rectangular sheet-like member and a lip 48 running around three sides extending perpendicularly away from the planar part. This lip 48 hangs over the top edges of the sidewalls 60 and front sidewall 30 when the lid is closed (refer also to FIG. 1).

Referring to FIG. 8, part way along the right hand lip 48, as viewed in FIG. 7, a slot 49 is provided. The arm 105 at the top of the side locking rod 100 may engage into the slot 49 so as to retain the lid in the open position. The slot 49 is arranged such that the rod 100 is prevented from sliding fully into the channel 80 created between the sidewall 60 and the rear sidewall 90 and their associated wall tabs 61, 71.

Also discernible in FIG. 8 are a lid tab 41 located on the lid 40, a side wall 60, the lid 40 and a lid tab 91 located on the rear sidewall 90. The rear lid tab 91 comprises a first portion 92 which extends perpendicularly away from the rear sidewall 90 and a second portion 93 which extends perpendicularly away from the first portion 92, downwardly towards the base and parallel to the rear side wall 90.

A view of a single wall tab 61 (for instance originally shown in FIG. 5) is shown looking down from above the box in FIG. 9. The tab 61 comprises a first portion 62 which extends away substantially perpendicularly from the edge 60A of the wall 60 and then a second potion 63 which extends away perpendicularly from the outer edge 62A of the first portion 62. The outer edge of the second portion has been referenced “63A”. FIG. 10 is a view of the tab 61 in the direction of the arrow referenced “B” in FIG. 9. The first portion 62 is seen to be trapezoidal in shape such that its width tapers away from the edge 60A of the wall 60. Likewise, FIG. 11 is a view of the tab 61 in the direction of the arrow referenced “C” in FIG. 9. The second portion 63 is seen to be trapezoidal in shape such that its width tapers away from the outer edge 62A of the first portion 62.

Although the first and second portions are shown to have both upper and lower sides tapering it is to be understood that either one or both sides may taper on either one or both of the first and second portions. The degree of tapering may be adjusted as required to ensure that the corresponding tabs on adjacent walls can pass one another and do not interfere with one another such that they interlock correctly during assembly. The outer corners of the second portion 63 may be rounded.

It is to be understood that the tabs may not include tapering but may have orthogonal corners. Alternatively, or additionally, to the tapering or non-tapering of the tabs, gaps may be left between adjacent tabs to prevent corresponding tabs from interfering with one another during assembly and disassembly of the box.

Although the total number of each type of tab (21, 41, 61, 71, 91) is discernible from the Figures it will be understood that the number of each may vary. Furthermore, even though the tabs ((21, 41, 61, 71, 91) have been shown to alternate (with one tab from a first side, base or lid, followed by a tab from a second side, base or lid) along each junction, other arrangements are contemplated such as two from a first side, followed by one from a second side.

1. A box capable of being assembled and disassembled comprising at least three sidewalls, a base, a lid, and removably insertable side locking rods, wherein the base and at least one sidewall comprise base connectors for releasably connecting the at least one sidewall with the base, and the sidewalls comprise side connectors arranged to accept the insertion of one of the side locking rods, such that with the box at least partially assembled each side locking rod releasably retains two adjacent sidewalls together, and wherein the box is arranged such that with the lid in the closed position the side locking rods are prevented from being removed by the lid, the box further comprising a removably insertable lid locking rod, and one of the sidewalls and the lid comprise lid connectors arranged to accept the insertion of the lid locking rod, so as to releasably retain the lid thereto, and wherein the box is arranged such that with the lid in the closed position the lid locking rod is prevented from being removed by the lid.

2. The box of claim 1, wherein the side connectors are arranged such that the side locking rods are internal to the box in their inserted positions.

3. The box of either one of claim 1, further comprising a lock for locking the lid in a closed position.

4. The box of claim 1, wherein the base, sidewalls and lid comprise sheet metal.

5. The box of claim 1, wherein the base comprises at least one foot.

6. The box of claim 1, wherein the base connectors include slots in the base and corresponding base tabs projecting from the at least one sidewall, the base tabs comprising a first portion co-planar with the at least one sidewall and a second portion in a plane perpendicular to the first portion such that with the at least one sidewall connected to the base the first portions are arranged in the slots and the second portions lie beneath, and substantially parallel to, the base.

7. The box of claim 1, wherein the side connectors comprise at least one wall tab provided along each of the two opposite sides of one of the at least three sidewalls, and at least one wall tab provided along at least one side of each of the two other sidewalls, each wall tab configured to accept a side locking rod inserted in a first direction and prevent the rod from moving in a second direction, perpendicular to the first direction, when two or more wall tabs are adjacent one another.

8. The box of claim 1, wherein the lid comprises a side locking rod receiver for receiving one end of a side locking rod for retaining the lid in an open position.

9. The box of claim 1, wherein the lid connector comprises at least one lid tab provided on the upper side of the sidewall and at least one lid tab provided on the lid, each lid tab configured to accept the lid locking rod inserted in a first direction and prevent the rod from moving in a second direction, perpendicular to the first direction, when two or more lid tabs are adjacent one another.

10. The box of claim 1, further including a door fixing member comprising a first member, integral with or fixed to the box, at least a portion of the first member being arranged to fit between a door and the door frame or door threshold, and a second member having a plane substantially perpendicular to the first member, wherein, in use, the first member is slidable between a door and the door frame or door threshold such that with the door closed the box is substantially immovable away from the door by virtue of the second member.

11. A box capable of being assembled and disassembled comprising at least three sidewalls, a base, a lid, and removably insertable side locking rods, wherein the base and at least one sidewall comprise base connectors for releasably connecting the at least one sidewall with the base, and the sidewalls comprise side connectors arranged to accept the insertion of one of the side locking rods, such that with the box at least partially assembled each side locking rod releasably retains two adjacent sidewalls together, and wherein the box is arranged such that with the lid in the closed position the side locking rods are prevented from being removed by the lid, the box further comprising a removably insertable lid locking rod a lock for locking the lid in a closed position, and one of the sidewalls and the lid comprise lid connectors arranged to accept the insertion of the lid locking rod, so as to releasably retain the lid thereto, wherein the box is arranged such that with the lid in the closed position the lid locking rod is prevented from being removed by the lid, and wherein the side connectors are arranged such that the side locking rods are internal to the box in their inserted positions.

12. The box claim 11, wherein the base connectors include slots in the base and corresponding base tabs projecting from the at least one sidewall, the base tabs comprising a first portion co-planar with the at least one sidewall and a second portion in a plane perpendicular to the first portion such that with the at least one sidewall connected to the base the first portions are arranged in the slots and the second portions lie beneath, and substantially parallel to, the base.

13. The box of claim 11, wherein the side connectors comprise at least one wall tab provided along each of the two opposite sides of one of the at least three sidewalls, and at least one wall tab provided along at least one side of each of the two other sidewalls, each wall tab configured to accept a side locking rod inserted in a first direction and prevent the rod from moving in a second direction, perpendicular to the first direction, when two or more wall tabs are adjacent one another.

14. The box of claim 11, wherein the lid comprises a side locking rod receiver for receiving one end of a side locking rod for retaining the lid in an open position.

15. The box of claim 11, wherein the lid connector comprises at least one lid tab provided on the upper side of the sidewall and at least one lid tab provided on the lid, each lid tab configured to accept the lid locking rod inserted in a first direction and prevent the rod from moving in a second direction, perpendicular to the first direction, when two or more lid tabs are adjacent one another.

16. The box of claim 11, further including a door fixing member comprising a first member, integral with or fixed to the box, at least a portion of the first member being arranged to fit between a door and the door frame or door threshold, and a second member having a plane substantially perpendicular to the first member, wherein, in use, the first member is slidable between a door and the door frame or door threshold such that with the door closed the box is substantially immovable away from the door by virtue of the second member.

17. A box capable of being assembled and disassembled comprising at least three sidewalls, a base, a lid, and removably insertable side locking rods, wherein the base and at least one sidewall comprise base connectors for releasably connecting the at least one sidewall with the base, and the sidewalls comprise side connectors arranged to accept the insertion of one of the side locking rods, such that with the box at least partially assembled each side locking rod releasably retains two adjacent sidewalls together, and wherein the box is arranged such that with the lid in the closed position the side locking rods are prevented from being removed by the lid, the box further comprising a removably insertable lid locking rod, and one of the sidewalls and the lid comprise lid connectors arranged to accept the insertion of the lid locking rod, so as to releasably retain the lid thereto, wherein the box is arranged such that with the lid in the closed position the lid locking rod is prevented from being removed by the lid, wherein the base connectors include slots in the base and corresponding base tabs projecting from the at least one sidewall, the base tabs comprising a first portion co-planar with the at least one sidewall and a second portion in a plane perpendicular to the first portion such that with the at least one sidewall connected to the base the first portions are arranged in the slots and the second portions lie beneath, and substantially parallel to, the base, and wherein the side connectors comprise at least one wall tab provided along each of the two opposite sides of one of the at least three sidewalls, and at least one wall tab provided along at least one side of each of the two other sidewalls, each wall tab configured to accept a side locking rod inserted in a first direction and prevent the rod from moving in a second direction, perpendicular to the first direction, when two or more wall tabs are adjacent one another.

18. The box of claim 17, wherein the side connectors are arranged such that the side locking rods are internal to the box in their inserted positions.

19. The box of claim 17, further comprising a lock for locking the lid in a closed position.

20. The box of claim 17, further including a door fixing member comprising a first member, integral with or fixed to the box, at least a portion of the first member being arranged to fit between a door and the door frame or door threshold, and a second member having a plane substantially perpendicular to the first member, wherein, in use, the first member is slidable between a door and the door frame or door threshold such that with the door closed the box is substantially immovable away from the door by virtue of the second member.
